(19) United States
(12) Patent Application Publication
(10) Pub. No.: US 2005/0094190 A1
(43) Pub. Date: May 5, 2005

(54) Method and system for transforming datastreams

(75) Inventors: John B. Condon, Berthoud, CO (US); Nenad Rijavec, Longmont, CO (US); Arthur R. Roberts, Boulder, CO (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/689,126

(22) Filed: Oct. 20, 2003

(51) Int. Cl. G06F 9/46; G06F 15/00

(52) U.S. Cl. 358/1.15; 718/105

(57) ABSTRACT

The present invention is related to a method and system for transforming a datastream. The method includes parsing the datastream into a plurality of work units in a first format and processing each of the plurality of work units by at least one compute node to convert each work unit into a second format. In another aspect, the system includes a central component for receiving the datastream in a first format, a plurality of sources in the central component, where each of the plurality of sources is associated with at least one transform, and at least one compute node coupled to the central component. According to the system of the present invention, the central component instantiates at least one source of the plurality of sources that parses the datastream into a plurality of work units in the first format, and distributes each of the work units to the at least one compute node, which converts each work unit into a second format.

### FIELD OF THE INVENTION

The present invention relates to formatting and outputting data and more particularly to a method and system for transforming a datastream from plurality of first formats to plurality of second formats.

### BACKGROUND OF THE INVENTION

Data can be described using a variety of datastream formats including PostScript, PDF, HP PCL, TIFF, GIF, JPEG, PPML and MO:DCA, to name but a few. While this provides great flexibility, it also presents problems for devices that are required to manipulate or interpret the data. For example, printers generally support datastream formats that are optimal for efficient and reliable printing. Thus, printers must be able to take a datastream formatted in a non-supported format and transform the datastream into a format suitable for printing. Indeed, datastream transformation lies at the heart of modem printing technology.

FIG. 1 is a block diagram of a typical printing system. The printing system includes a plurality of users 10a-10n coupled to a printer server 12 via a network 11. The printer server 12 includes a plurality of datastream transforms 14 that convert a datastream from a first format to a second format. Generally, the transforms 14 are implemented as self-contained software applications and, in some circumstances, on dedicated hardware. Datastream transforms 14 are well known in the art and are readily available for most input/output datastream formats. Each transform 14 is a stand alone component that is coordinated, configured and invoked by another component such as the print server 12 or print controller. The printer server 12 is coupled to a plurality of printers 20a-20n to which the transformed datastreams are passed for printing.

Modem computing systems that perform datastream transformations utilize multiple parallel processors (or compute nodes) to increase the speed by which a datastream is transformed. Nevertheless, in order to take advantage of parallel processing, developers must write separate applications for each different transform. This task is a tedious and inefficient process, particularly considering that many functions in processing are redundant.

In addition, managing, updating and configuring multiple transforms in modem computing systems can be difficult, particularly if the system supports a large number of input data formats. For example, a print server such as the Infoprint Manager™ developed by International Business Machines of Armonk, N.Y., supports, among others, PostScript, PDF, HP PCL, TIFF, GIF, JPEG, PPML and MO:DCA.

Accordingly, a need exists for a system and method for providing a consistent and configurable transform system. The system should optimize processing efficiency in a parallel processing environment and should provide facilities to install, update, configure, manage and use transforms for multiple datastreams on input and output. The present invention addresses such a need.

### SUMMARY OF THE INVENTION

The present invention is related to a method and system for transforming a datastream.

The method includes parsing the datastream into a plurality of work units in a first format and processing each of the plurality of work units by at least one compute node to convert each work unit into a second format. In another aspect, the system includes a central component for receiving the datastream in a first format, a plurality of sources in the central component, where each of the plurality of sources is associated with at least one transform, and at least one compute node coupled to the central component. According to the system of the present invention, the central component instantiates at least one source of the plurality of sources that parses the datastream into a plurality of work units in the first format, and distributes each of the work units to the at least one compute node, which converts each work unit into a second format.

Through the aspects of the present invention, a transform mechanism provides an abstraction of the concepts and operations that are common to processing any type of datastream format. The transform mechanism manages tasks common for all datastreams, such as, for example, transform invocation, dynamic load balancing between a plurality of parallel compute nodes, output sequencing, error management, transform library management and node management. The transform mechanism can be coupled to different front end components to support datastream transformations. Such front end components include printer server systems and document storage systems. Accordingly, the transform mechanism provides a powerful, yet flexible, system that manages different transform solutions with efficiency.

### BRIEF DESCRIPTION OF THE DRAWINGS

FIG. 1 is a block diagram of a typical printing system.

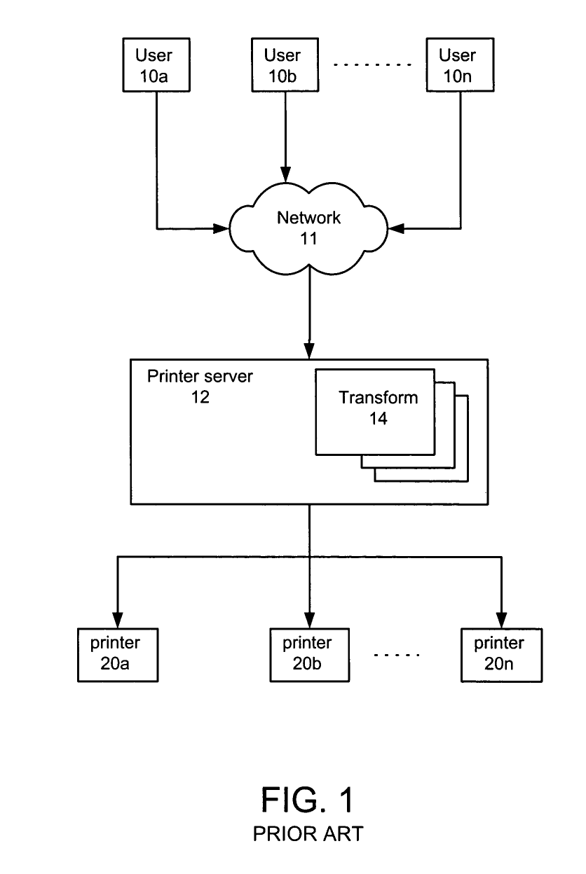

FIG. 2A is a block diagram illustrating a printing system according to a preferred embodiment of the present invention.

FIG. 2B is a block diagram illustrating a printing system according to another preferred embodiment of the present invention.

FIG. 3 illustrates a block diagram illustrating the transform mechanism according to a preferred embodiment of the present invention.

FIG. 4 is a block diagram illustrating a datastream flow during a transformation process according to a preferred embodiment of the present invention.

FIG. 5 is a flowchart illustrating a method for transforming a datastream according to a preferred embodiment of the present invention.

### DETAILED DESCRIPTION

The present invention relates to formatting and outputting data and more particularly to a method and system for transforming a datastream from a first format to a second format. The following description is presented to enable one of ordinary skill in the art to make and use the invention and is provided in the context of a patent application and its requirements. While a preferred embodiment of the present invention involves a parallel processing system, various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

According to the present invention, a transform mechanism manages tasks common for all datastreams, regardless of format, in parallel datastream processing. Such tasks include load balancing, output sequencing, error management, transform management, compute node management and resource management. The transform mechanism is implemented as a set of executables, libraries, API specifications and processing policies and conventions.

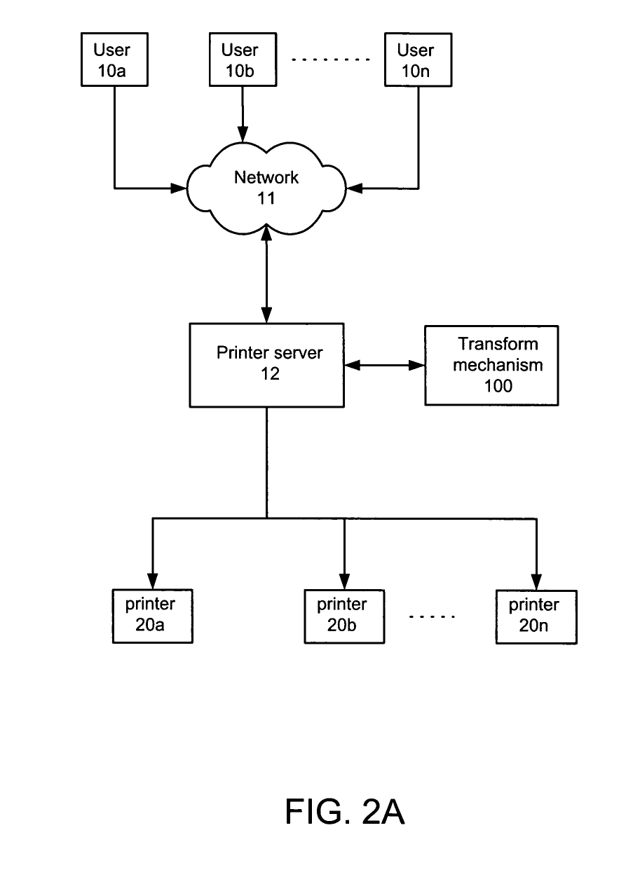

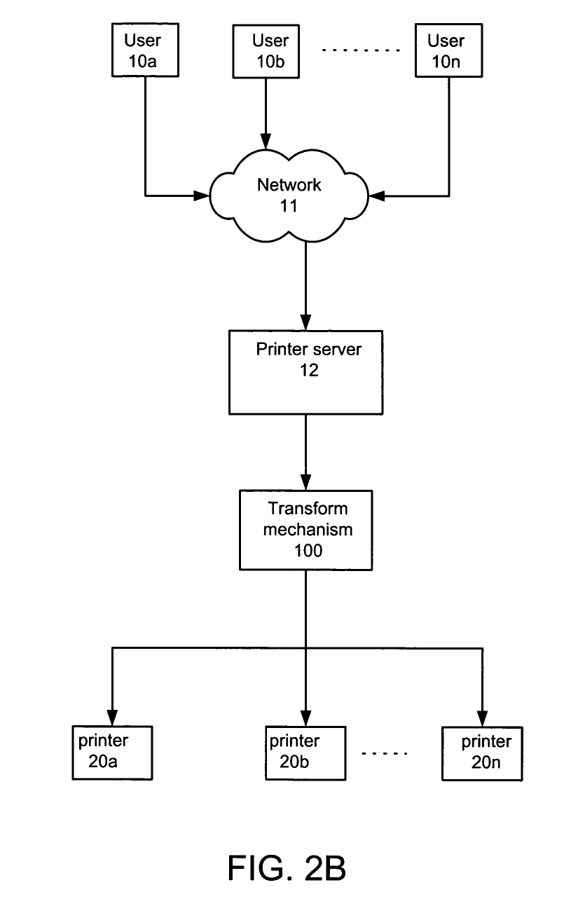

FIG. 2A is a block diagram illustrating a printing system according to a preferred embodiment of the present invention. Like components are designated by like item numerals. As is shown, the transform mechanism 100 communicates with the printer server 12. FIG. 2B illustrates a printing system according to another preferred embodiment of the present invention where the transform mechanism 100 is coupled to the server 12 and to the plurality of printers 20a-20n. According to both preferred embodiments, the server 12 utilizes the transform mechanism 100 to transform a datastream from a first format to a second format.

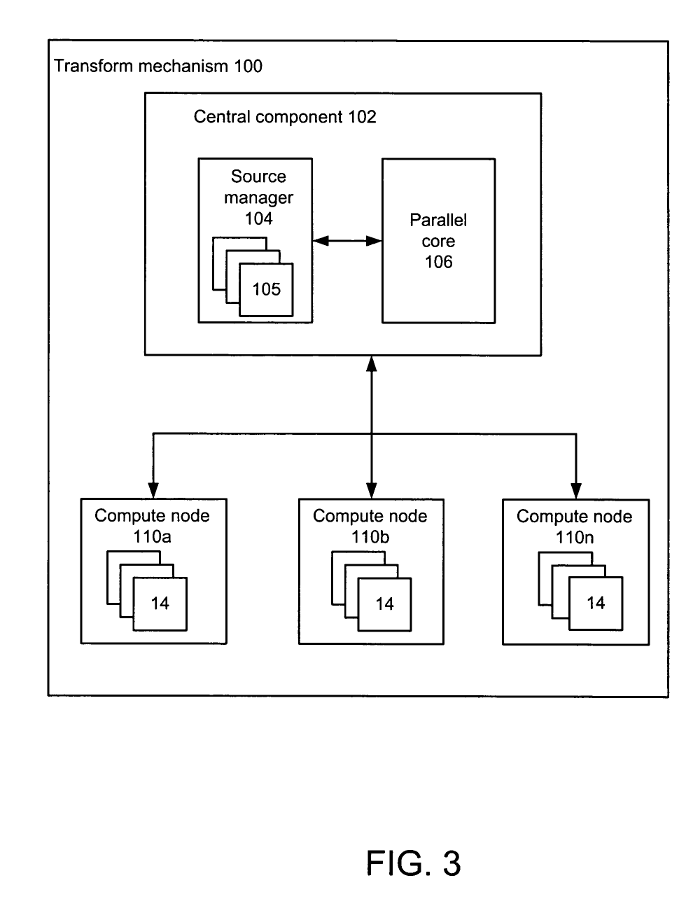

To describe the present invention in more detail, please refer now to FIG. 3 which is a block diagram illustrating the transform mechanism 100 according to a preferred embodiment of the present invention. As is shown, the transform mechanism 100 has two parts: a central component 102 and a cluster of compute nodes 10a-10n. The central component 102 includes a source manager 104 coupled to a parallel core 106. The central component 102 is coupled to the cluster of compute nodes 110a-110n. Each compute node 110a-110n includes and is configured to load one or more datastream transforms 14 preferably as dynamic libraries, e.g., plug-ins. According to a preferred embodiment, the central component 102 manages datastream independent functions and the compute nodes 110a-110n handle the datastream processing, i.e. transformation.

The source manager 104 includes a plurality of sources 105. Each source 105 is a unit of one or more processing threads that accepts data and/or commands from an external interface. Each source 105 is associated with and accepts a particular datastream format and handles format-specific operations.

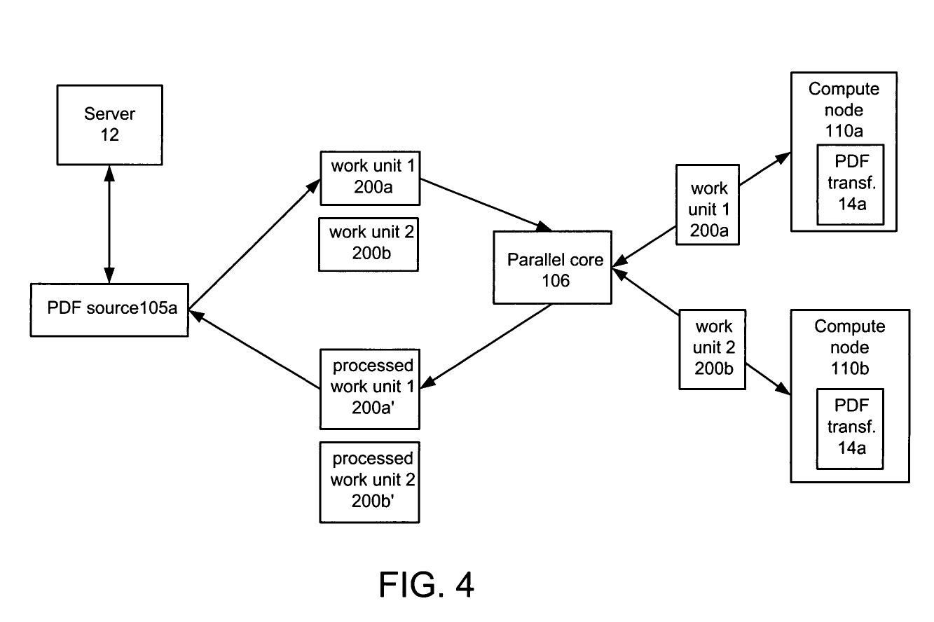

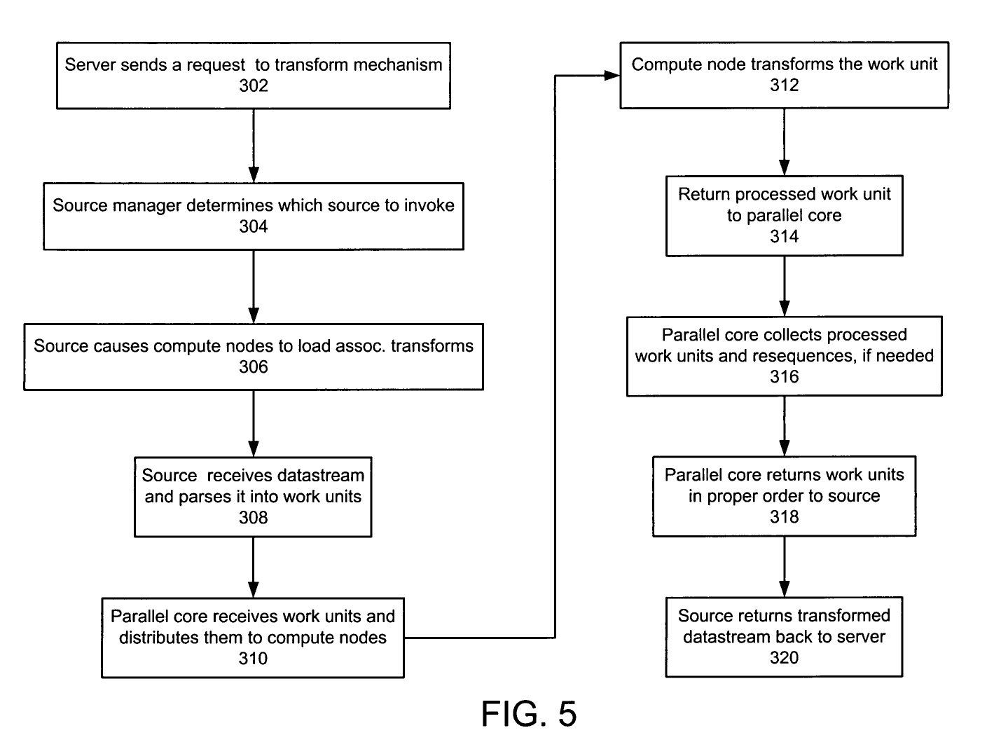

Each component will be described below with reference to FIGS. 4 and 5. FIG. 4 is a block diagram illustrating a datastream flow during a transformation process according to a preferred embodiment of the present invention. FIG. 5 is a flowchart illustrating a method for transforming a datastream according to a preferred embodiment of the present invention. In FIG. 5, the method begins in step 302 when the server 12 sends a request to the transform mechanism 100 to transform a datastream. The source manager 104 receives the request and determines which source 105 to instantiate, e.g., by examining a signature in the request in step 304. The signature can explicitly identify a particular source or it can indicate where the source is located, e.g., “load source mypath/myprogram.lib.” So, for example, if the server 12 requests a datastream transformation from PDF to AFP, the source manager 104 identifies and loads the PDF source 105a, preferably as a dynamic library.

Each source 105 is associated with one or more transforms 14. For example a source that handles a PPML datastream requires PostScript, PDF, TIFF and JPEG transforms. Once instantiated, the source 105a requests that the associated transform(s) 14a be loaded by the cluster of computer nodes 110a-110n, via step 306. Once the transforms 14a are loaded, the source 105a begins accepting data and commands from the server 12. The source 105a parses the information into a stream of work units 200a, 200b in step 308. Each work unit, e.g., 200a is designed to be independent of other work units, e.g., 200b, in the stream. As an independent unit of work, the work unit 200a includes all information need to process the work unit 200a.

In a preferred embodiment, there are two types of work units: data and control. The data work unit contains actual data to be processed. A data work unit can be either complete or incremental. A complete work unit contains all the data needed to process it. An incremental work unit contains all the control data but not the data to be processed. If a work unit is incremental, the compute node, e.g., 110a, will call a “get data” API provided by the source 105 to obtain more data. The API will indicate that compute node 110a has all the data for the work unit by setting the appropriate return code. In a preferred embodiment, each data work unit contains one type of data such that a compute node, e.g., 110a, can process it by loading a single transform 14a. Accordingly, each compute node 110a, 110b will preferably process one data work unit at a time.

The control work unit contains commands for compute nodes. Control work units can either apply to all or some compute nodes. These work units are generated indirectly by the sources 105, e.g., a source 105 calls a particular command API which then generates and issues an appropriate control work unit. Control work unit distribution can be “scheduled,” “immediate” and “interrupt.” A “scheduled” control work unit is processed after all the work units currently in a queue have been dispatched to the compute nodes. An “immediate” control work unit is put at the front of the queue and is processed by the compute nodes 110a, 110b as they finish processing their current work units. An “interrupt” work unit is passed to the relevant compute node(s) immediately, without waiting for the current work unit to finish. In a preferred embodiment, the source manager 104 also includes a control source (not shown) that, unlike the other sources 105, does not process datastreams but offers a command and control channel for configuring, updating and debugging.

After parsing the data into work units 200a, 200b, the source 105a submits the work units 200a, 200b to the parallel core 106. After the parallel core 106 receives the work units 200a, 200b, it schedules and distributes the work units 200a, 200b to different compute nodes 110a, 110b for processing in step 310. The parallel core 106 preferably maintains queues of work units 200a, 200b from which the compute nodes 110a, 110b obtain the next available work unit. While a variety of scheduling algorithms can be used that are well known in the art, a simple first-in-first-out scheme is utilized in the preferred embodiment.

In step 312, each compute node 110a, 110b transforms, i.e., processes, the work unit 200a, 200b. The processed work units 200a′, 200b′ are returned to the parallel core 106 in step 314. As each compute node 110a completes its current work unit 200a, it takes the first queued work unit (not shown) and continues processing.

In the dynamic load balancing model, the work units 200a, 200b often are completed out of order. Accordingly, in step 316, the parallel core 106 collects the processed work units 200a′, 200b′ and, if needed, sequences the processed work units 200a′, 200b′ in the proper order before returning them to the source 105a in step 318. In another embodiment, as each compute node 110a, 110bprocesses the work unit 200a, 200b, the processed data is cached for return to the parallel core 106. The parallel core 106 instructs each compute node 110a, 110b when to start sending the cached data so that it receives the processed work units 200a′, 200b′ in proper order. In this embodiment, a processed work unit, e.g., 200a′ may be cached, while the compute node 110a begins processing a next work unit (not shown). In addition to the processed data 200a′, 200b′, the parallel core 106 also returns error, status, log and trace information to the source 105a.

Finally, in step 320, the source 105a returns the transformed datastream back to the server 12. In another preferred embodiment, the source 105a passes the transformed datastream directly to the appropriate printer, e.g., 20b (FIG. 2B), bypassing the server 12. Once the source 105a has completed its task, i.e., the connection from the server 12 is closed, and the transforms 14a required by the source 105a are unloaded if no other source requires them.

Although the above described method is presented as a sequence of steps, it should be noted that the input from the server 12 is a continuous datastream. Moreover, the source manager 104 can instantiate multiple sources 105 such that multiple datastreams of the same or different formats can be processed concurrently producing the same or different output formats depending on user requirements. It is likely that as the parallel core 106 receives work units 200a, 200b from one or more sources 105 and distributes these work units to different compute nodes 110a, 110a (step 310), the parallel core 106 is simultaneously preparing processed work units 200a′, 200b for transmission back to the proper source 105 (steps 316, 318). Accordingly, the source 105 and the parallel core 106 are constantly occupied during one or more transformation tasks.

While the preferred embodiment has been described in the context of a printing environment, i.e., the transform mechanism 100 is coupled to a print server 12, the present invention is not limited to such environments. The transform mechanism 100 can be coupled to any front end application that requires datastream transformations. For example, the transform mechanism 100 can be coupled to an image storage processing system that transforms an object into a format optimal for storage.

As stated above, the transform mechanism 100 manages datastream independent tasks involved in parallel datastream processing. Such tasks include error management, resource management, and compute node management. According to the preferred embodiment, each task can be performed without interrupting datastream processing. Each task will be discussed below.

Error Management

If a source 105 requires full reliability, the source 105 saves each work unit 200a, 200b until the processing is completed so that a work unit 200a can be resubmitted for processing if the compute node 110a fails. The parallel core 106 reports the proper error code, e.g., node failure and other error related information, but does not resubmit the work unit 200a to a different compute node 110b. If a work unit 200b fails due to a data or resource problem, the transform in the compute node 110b reports the relevant error code to the parallel core 106. The error code is propagated back to the source 105, which can then take appropriate action, such as interrupting all the remaining work units and terminating the job.

Data Resource Management

A variety of datastreams, such as MO:DCA, PPML and PostScript, use a resource mechanism to identify recurring parts of the datastream, so that the relevant data can be downloaded and processed only once. If work unit 200a requires such a resource, compute node 110a notifies the parallel core 106, which in turn requests the resource from the source 105. Parallel core 106 passes the resource to the node 110a and records the resource signature. The signature is private to the source 105 and to the corresponding transform. The signature will commonly include the fully qualified reference to the original resource, as well as usage, such as position and orientation in the output datastream.

If the same resource is required to process another work unit 200b, compute node 110b again notifies the parallel core 106. This time, the parallel core 106 may instruct the node 110 b to obtain the resource from the node 110a, instead of requesting source 105 to send it. Depending on the nature of the output datastream, the node 110a may have a cached version of the transformed resource that is significantly easier to use than the original. Even if this is not the case, sending the resource between the nodes may improve performance by shifting bandwidth requirements to the different parts of the network.

Program Resource Management

Program resource management refers to managing source and transform libraries and the resources used by the libraries. The resources are defined as file packages and are first stored in a directory tree in the central component 102. To propagate the resources to the compute nodes 110 a, 110 b, the compute nodes 110a, 110b are informed of the relative path of the file package. In general, the directory tree will be available to each compute node 110a, 110b with a known root and a compute node 110a can then obtain and install the file package in its own directory tree. In this manner, the transform mechanism 100 is capable of updating resources, including the transforms, while processing data.

In a preferred embodiment, resource and code updates are packaged as directory trees and transported as some sort of an archive file, e.g., zip or .tar.Z. Upon unpacking, the root directory of the each package contains an “update.sh” shell script that performs an actual update. The script returns a zero return code on success, nonzero return code on failure. It should take a single parameter that indicates the directory tree to be updated. The transform mechanism 100 backs up the directory tree first and then applies the update. If the update fails, the archived files are restored. If, at some point, there is a need to roll back several updates, it can be done as another “logical update,” such that a mechanism to reject more than the last update is not required.

Node Management

According to the preferred embodiment of the present invention, compute nodes can be added or removed dynamically without interrupting the datastream transformation process. Node management is performed via a “control source”. If a new compute node is introduced, the compute node registers with the central component 102, e.g., by connecting to a known socket. This invokes the command source which then proceeds to provide the new compute node with all resource updates needed so that it is in sync with other compute nodes. After the resources are updated, the command source calls a “register” API that initiates the compute node, e.g., starts the relevant threads, instantiates the node control data structures, and opens sockets. After the initialization is done and all the sockets are open, the compute node can start processing data.

To terminate a compute node, the command for doing so is given to the command source. The command source, in turn, issues a control work unit for the node instructing it to terminate. Upon receipt of the work unit, the compute node propagates back all the spooled data still held on the node, issues the terminate command to the node, closes all the sockets and terminates the threads servicing the compute node. Similar actions would be taken if a node failed in some manner and the sockets just closed.

Through aspects of the present invention, datastream independent operations involved in parallel datastream processing are managed by the transform mechanism 100. According to the preferred embodiment of the present invention, the following common functions are implemented in a datastream independent manner:
Loading and unloading transforms
Loading and unloading sources
Adding and removing compute nodes
Resource management
Code library updates, e.g., installing a new version of a transform or source
Dynamic load balancing
Output sequencing
Logging and tracing

Although the present invention has been described in accordance with the embodiments shown, one of ordinary skill in the art will readily recognize that there could be variations to the embodiments and those variations would be within the spirit and scope of the present invention. For example, while the preferred embodiment involves a parallel processing environment, those skilled in the art would readily appreciate that the principles of the present invention could be utilized in a variety of processing environments, e.g., single processor environment. Accordingly, many modifications may be made by one of ordinary skill in the art without departing from the spirit and scope of the appended claims.

1. A method for transforming a datastream comprising the steps of:
a) parsing the datastream into a plurality of work units in a first format; and
b) processing each of the plurality of work units by at least one compute node to convert each work unit into a second format.

2. The method of claim 1, wherein the parsing step (a) includes:
(a1) providing a plurality of sources, wherein each source is associated with at least one transform;
(a2) instantiating at least one source of the plurality of sources, wherein the at least one instantiated source is associated with the datastream format; and
(a3) utilizing the at least one source to parse the datastream.

3. The method of claim 2, wherein the processing step (b) includes:
(b1) loading the at least one transform associated with the at least one instantiated source in the at least one compute node; and
(b2) utilizing the at least one transform to convert a work unit of the plurality of work units from the first format to the second format.

4. The method of claim 2 further comprising:
(c) load balancing the plurality of work units.

5. The method of claim 4 wherein the load balancing step includes:
(c1) generating at least one queue for the plurality of work units; and
(c2) distributing each work unit from the at least one queue to the at least one compute nodes in an order.

6. The method of claim 5 further comprising:
(d) returning the plurality of processed work units from the at least one compute node to the at least one source in the order it was distributed.

7. The method of claim 1, wherein at least one of the plurality of work units is a control work unit that includes control commands for the at least one compute node.

8. The method of claim 7, wherein the processing step (b) includes
(b1) executing the control commands in the control work unit.

9. The method of claim 2, wherein the at least one source is instantiated as a dynamic library.

10. A computer readable medium containing program instructions for transforming a datastream, the program instructions for:
a) parsing the datastream into a plurality of work units in a first format; and
b) processing each of the plurality of work units by at least one compute node to convert each work unit into a second format.

11. The computer readable medium of claim 10, wherein the parsing instruction (a) includes:
(a1) providing a plurality of sources, wherein each source is associated with at least one transform;
(a2) instantiating at least one source of the plurality of sources, wherein the at least one instantiated source is associated with the datastream format; and
a3) utilizing the at least one source to parse the datastream.

12. The computer readable medium of claim 11, wherein the processing instruction (b) includes:
(b1) loading the at least one transform associated with the at least one instantiated source in the at least one compute node; and
(b2) utilizing the at least one transform to convert a work unit of the plurality of work units from the first format to the second format.

13. The computer readable medium of claim 11 further comprising:
(c) load balancing the plurality of work units.

14. The computer readable medium of claim 13, wherein the load balancing instruction includes:
(c1) generating at least one queue for the plurality of work units; and
(c2) distributing each work unit from the at least one queue to the at least one compute nodes in an order.

15. The computer readable medium of claim 14 further comprising:
(d) returning the plurality of processed work units from the at least one compute node to the at least one source in the order it was distributed.

16. The computer readable medium of claim 10, wherein at least one of the plurality of work units is a control work unit that includes control commands for the at least one compute node.

17. The computer readable medium of claim 16, wherein the processing instruction (b) includes
(b1) executing the control commands in the control work unit.

18. The computer readable medium of claim 11, wherein the at least one source is instantiated as a dynamic library.

19. A system for transforming a datastream comprising:
a central component for receiving the datastream in a first format;
a plurality of sources in the central component, wherein each of the plurality of sources is associated with at least one transform; and
at least one compute node coupled to the central component,
wherein the central component instantiates at least one source of the plurality of sources that parses the datastream into a plurality of work units in the first format, and distributes each of the work units to the at least one compute node, wherein the at least one compute node converts each work unit into a second format.

20. The system of claim 19, wherein each of the at least one compute nodes loads the at least one transform as a dynamic library and utilizes the at least one transforms to convert a work unit in the first format to the second format.

21. The system of claim 19, wherein the central component further includes:
a load balancing mechanism coupled to the at least one source for distributing the plurality of work units to the at least one compute node, wherein the load balancing mechanism generates at least one queue for the plurality of work units and dispatches each work unit from the at least one queue to the at least one compute node in an order received from the at least one source.

22. The system of claim 21, wherein the work units processed by the at least one compute node are returned to the at least one source in the order in which the work units were dispatched.

23. The system of claim 19, wherein at least one of the plurality of work units is a control work unit that includes commands for the at least one compute node.

24. The system of claim 23, wherein the at least one compute node processes the control work unit by executing the command.

25. The system of claim 19, wherein the at least one source is instantiated as a dynamic library.
